(19) United States
(12) Patent Application Publication
(10) Pub. No.: US 2026/0200450 A1
(43) Pub. Date: Jul. 16, 2026

(54) BRAKING DEVICE

(71) Applicant: ADVICS CO., LTD., Kariya-shi, Aichi-ken (JP)

(72) Inventors: Masataka SAKAUE, Kariya-shi, Aichi-ken (JP); Kazutoshi YOGO, Kariya-shi, Aichi-ken (JP)

(73) Assignee: ADVICS CO., LTD., Kariya-shi, Aichi-ken (JP)

(21) Appl. No.: 19/135,891

(22) PCT Filed: Dec. 8, 2023
(86) PCT No.: PCT/JP2023/044001

§ 371 Date: Jun. 5, 2025

(30) Foreign Application Priority Data
Dec. 8, 2022 (JP) 2022-196317

(51) Int. Cl. B60T 13/74; B60T 17/06; B60T 17/22

(52) U.S. Cl. CPC B60T 13/745; B60T 17/06; B60T 17/22; B60T 2270/88

(57) ABSTRACT

When a deviation in an output of a control pressure sensor is confirmed, a control unit executes output calibration for the control pressure sensor in a state where a piston of an electric cylinder is moved in retreat direction Zb from a standby position.

### TECHNICAL FIELD

The disclosure here relates to a braking device including an electric cylinder.

### BACKGROUND ART

A device disclosed in PTL 1 has been known as a braking device including an electric cylinder. The electric cylinder includes a piston movably accommodated in the cylinder, a hydraulic chamber defined by a peripheral wall of the cylinder and the piston, and an electric motor that drives the piston. The braking device generates a braking force by supplying a brake fluid, which is discharged by the electric cylinder, to a wheel cylinder. The braking device further includes a hydraulic pressure sensor that detects a hydraulic pressure of the brake fluid discharged by the electric cylinder.

### CITATION LIST

### Patent Literature

PTL 1: JP2009-137376A

### SUMMARY

### Technical Problem

Output characteristics of the hydraulic pressure sensor provided in such a braking device may change depending on environmental conditions or the like. The detection accuracy of the hydraulic pressure sensor may decrease due to the change in the output characteristics.

### Solution to Problem

A braking device for solving the above problem includes a reservoir tank configured to store a brake fluid, an electric cylinder configured to discharge the brake fluid by moving a piston in the cylinder in response to driving by an electric motor, a hydraulic pressure sensor configured to detect a hydraulic pressure of the brake fluid discharged by the electric cylinder, and a control unit configured to control the electric motor. The braking device generates a braking force on a wheel by supplying the brake fluid to a wheel cylinder in response to discharge of the brake fluid from the electric cylinder. The electric cylinder of the braking device includes a hydraulic chamber defined by a peripheral wall of the cylinder and the piston, an input port that is an inlet for the brake fluid from the reservoir tank to the hydraulic chamber, and an output port that is an outlet for the brake fluid from the hydraulic chamber. The electric cylinder is configured such that the input port is opened when the piston is positioned at a retreat limit position, and when the piston is moved in a forward direction from the retreat limit position and the input port is closed, the hydraulic pressure in the hydraulic chamber increases and the brake fluid is discharged from the output port. The control unit of the braking device holds the piston at a standby position set between a position where the input port is switched between a closed state and an opened state and the retreat limit position when generation of the braking force is not requested. The control unit controls the electric motor to move the piston in the forward direction from the standby position when the generation of the braking force is requested. The control unit executes calibration processing of executing output calibration for the hydraulic pressure sensor after commanding the electric motor to move the piston in a retreat direction relative to the standby position. Here, the forward direction indicates a moving direction of the piston for reducing a volume of the hydraulic chamber. The retreat direction here indicates a direction opposite to the forward direction. The retreat limit position here indicates a furthest position in the retreat direction in a movable range of the piston.

At the start of the calibration processing, there is a possibility that the piston is not retreated to the standby position and the input port is not opened. In response to this, in the calibration processing, the control unit of the braking device commands the electric motor to move the piston in the retreat direction relative to the standby position, and then executes the output calibration for the hydraulic pressure sensor. Therefore, even if the input port is not opened at the start of the calibration processing, there is a high possibility that the input port is opened when executing the output calibration. Therefore, the output calibration for the hydraulic pressure sensor is easily executed on the premise that the hydraulic pressure has a value equivalent to the atmospheric pressure. Therefore, the braking device has an effect of easily maintaining the detection accuracy of the hydraulic pressure sensor with respect to a change in output characteristics.

Another braking device for solving the above problem includes a reservoir tank configured to store a brake fluid, an electric cylinder configured to discharge the brake fluid by moving a piston in the cylinder in response to driving by an electric motor, a hydraulic pressure sensor configured to detect a hydraulic pressure of the brake fluid discharged by the electric cylinder, and a control unit configured to control the electric motor. The braking device generates a braking force on a wheel by supplying the brake fluid to a wheel cylinder in response to discharge of the brake fluid from the electric cylinder. The electric cylinder of the braking device includes a hydraulic chamber defined by a peripheral wall of the cylinder and the piston, an input port that is an inlet for the brake fluid from the reservoir tank to the hydraulic chamber, and an output port that is an outlet for the brake fluid from the hydraulic chamber. The electric cylinder is configured such that the input port is opened when the piston is positioned at a retreat limit position, and when the piston is moved in a forward direction from the retreat limit position and the input port is closed, the hydraulic pressure in the hydraulic chamber increases and the brake fluid is discharged from the output port. The braking device further includes a release flow path configured to communicate the output port with the reservoir tank without passing through the hydraulic pressure chamber, and a release valve configured to open and close the release flow path. The control unit of the braking device holds the piston at a standby position set between a position where the input port is switched between a closed state and an opened state and the retreat limit position when generation of the braking force is not requested. The control unit controls the electric motor to move the piston in the forward direction from the standby position when the generation of the braking force is requested. Further, the control unit executes calibration processing of executing output calibration for the hydraulic pressure sensor in a state where the release valve is opened.

In the calibration processing, the control unit of the braking device executes the output calibration for the hydraulic pressure sensor after opening the release valve. When the release valve is opened, the output port of the electric cylinder and the reservoir tank communicate with each other via the release flow path. Therefore, the hydraulic pressure to be detected by the hydraulic pressure sensor has a value equivalent to the atmospheric pressure regardless of whether the input port is opened. Therefore, the output calibration for the hydraulic pressure sensor can be executed on the premise that the hydraulic pressure has a value equivalent to the atmospheric pressure. Therefore, the braking device has an effect of easily maintaining the detection accuracy of the hydraulic pressure sensor with respect to a change in output characteristics.

### BRIEF DESCRIPTION OF DRAWINGS

FIG. 1 is a diagram schematically illustrating an example of a configuration of a braking device according to a first embodiment and a second embodiment.

FIG. 2 is a flowchart of a calibration routine executed by a control unit provided in the braking device according to the first embodiment.

FIG. 3 is a flowchart of a calibration routine executed by a braking portion provided in the braking device according to the second embodiment.

### DESCRIPTION OF EMBODIMENTS

### First Embodiment

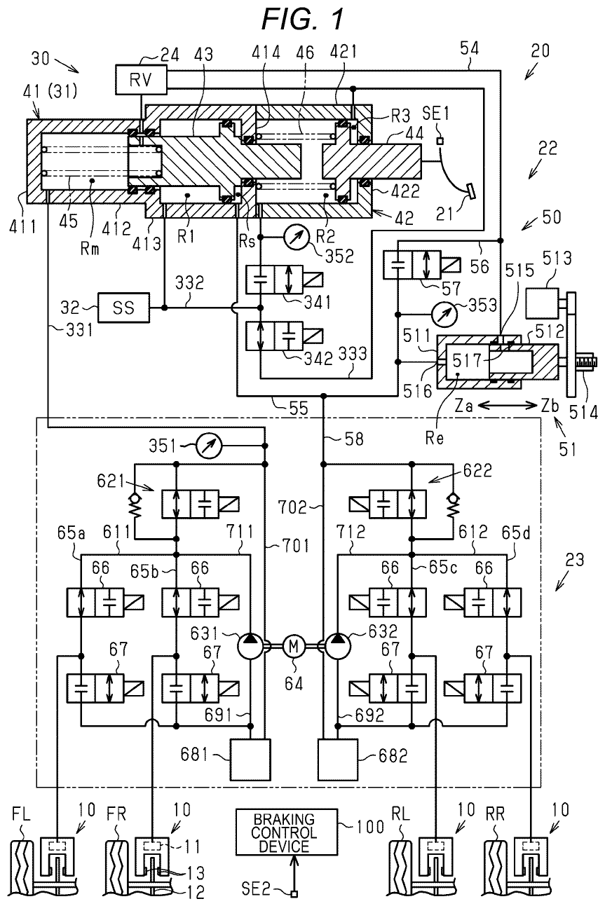

A braking device according to a first embodiment will be described with reference to FIGS. 1 to 3. FIG. 1 illustrates a plurality of wheels and a plurality of braking mechanisms 10 together with a braking device 20 according to the embodiment. The plurality of wheels include two front wheels and two rear wheels. For example, in FIG. 1, a wheel FL indicates a left front wheel, a wheel FR indicates a right front wheel, a wheel RL indicates a left rear wheel, and a wheel RR indicates a right rear wheel.

### Configuration of Braking Mechanism 10

First, a configuration of the braking mechanism 10 will be described. One braking mechanism 10 is provided for each wheel. Each braking mechanism 10 includes a wheel cylinder 11 to which a brake fluid is supplied, a rotary plate 12 that rotates integrally with the wheel, and a friction material 13 that is pressed against the rotary plate 12. The braking mechanism 10 generates a braking force on the wheel by pressing the friction material 13 against the rotary plate 12 by a hydraulic pressure supplied to the wheel cylinder 11.

### Configuration of Braking Device 20

Next, a configuration of the braking device 20 will be described. The braking device 20 includes a braking operation member 21, a hydraulic pressure generation device 22, a braking actuator 23, a reservoir tank 24, and a control unit 100. The braking operation member 21 is a member operated when a driver requests braking of a vehicle. An example of the braking operation member 21 is a brake pedal. The reservoir tank 24 is a tank that stores the brake fluid. The reservoir tank 24 is open to the atmosphere. Therefore, a hydraulic pressure of the brake fluid in the reservoir tank 24 is substantially equal to the atmospheric pressure. The hydraulic pressure generation device 22 is a device that generates a hydraulic pressure according to an operation of the braking operation member 21. The hydraulic pressure generation device 22 includes a master device 30 and a braking portion 50. The master device 30 can supply the brake fluid to the braking actuator 23. The braking portion 50 can supply the brake fluid to both the master device 30 and the braking actuator 23. The control unit 100 controls an operation of the braking device 20.

### Configuration of Master Device 30

Next, a configuration of the master device 30 will be described. The master device 30 includes a master cylinder 31 and a stroke simulator 32.

The master cylinder 31 includes a main cylinder 41 and a cover cylinder 42. The master cylinder 31 further includes a master piston 43 and an input piston 44. The master cylinder 31 further includes a master spring 45 that biases the master piston 43 and an input spring 46 that biases the input piston 44. The master piston 43 and the input piston 44 can move relative to the main cylinder 41 and the cover cylinder 42.

The main cylinder 41 of the master cylinder 31 has a plate-shaped bottom wall 411 and a first peripheral wall 412 extending from the bottom wall 411 along an axis of the bottom wall 411. The main cylinder 41 further includes a second peripheral wall 413 extending from a rear end of the first peripheral wall 412 along an axis of the first peripheral wall 412, and a first annular wall 414 extending from a rear end of the second peripheral wall 413 toward an axis of the second peripheral wall 413. Each of the first peripheral wall 412 and the second peripheral wall 413 has a tubular shape. A hole into which a rear end portion of the master piston 43 described later is inserted is formed in the first annular wall 414. An inner diameter of the first peripheral wall 412 is smaller than an inner diameter of the second peripheral wall 413.

A master chamber Rm is defined in the main cylinder 41 by the bottom wall 411, the first peripheral wall 412, and the master piston 43. Hereinafter, in the master cylinder 31, a left side in FIG. 1, that is, a moving direction of the master piston 43 for reducing a volume of the master chamber Rm is referred to as a “front side”, and a direction opposite to the front side is referred to as a “rear side”. The rear side is also a direction for increasing the volume of the master chamber Rm.

In the main cylinder 41, a first fluid chamber R1 is defined by the second peripheral wall 413 and the master piston 43, and a servo chamber Rs is defined by the second peripheral wall 413, the first annular wall 414, and the master piston 43. The master chamber Rm is formed at a position near a front end of the master cylinder 31. The first fluid chamber R1 is formed behind the master chamber Rm. The servo chamber Rs is formed behind the first fluid chamber R1. Inside the main cylinder 41, the master chamber Rm, the first fluid chamber R1, and the servo chamber Rs are not connected to each other.

The cover cylinder 42 of the master cylinder 31 includes a tubular third peripheral wall 421 and a second annular wall 422 extending from a rear end of the third peripheral wall 421 toward an axis of the third peripheral wall 421. The third peripheral wall 421 is attached to the first annular wall 414 such that the axis thereof coincides with the axis of the second peripheral wall 413 of the main cylinder 41. The second annular wall 422 is provided with a hole into which a rear end portion of the input piston 44 described later is inserted.

In the cover cylinder 42, a second fluid chamber R2 is defined by the first annular wall 414 of the main cylinder 41, the third peripheral wall 421, and the input piston 44. In the cover cylinder 42, a third fluid chamber R3 is defined by the third peripheral wall 421, the second annular wall 422, and the input piston 44. In the master cylinder 31, the second fluid chamber R2 is formed behind the servo chamber Rs. In the master cylinder 31, the third fluid chamber R3 is formed behind the second fluid chamber R2. The second fluid chamber R2 and the third fluid chamber R3 are not connected to each other inside the cover cylinder 42.

The master piston 43 is accommodated in the master cylinder 31 in surface contact with an inner peripheral surface of the first peripheral wall 412, an inner peripheral surface of the second peripheral wall 413, and an inner peripheral surface of the first annular wall 414 of the main cylinder 41. Therefore, when the master piston 43 moves in an axial direction, the master piston 43 slides on the inner peripheral surface of the first peripheral wall 412, the inner peripheral surface of the second peripheral wall 413, and the inner peripheral surface of the first annular wall 414. The rear end portion of the master piston 43 protrudes further rearward relative to the first annular wall 414 and is positioned in the second fluid chamber R2.

The input piston 44 is accommodated in the master cylinder 31 in surface contact with an inner peripheral surface of the third peripheral wall 421 and an inner peripheral surface of the second annular wall 422 of the cover cylinder 42. Therefore, when the input piston 44 moves in an axial direction, the input piston 44 slides on the inner peripheral surface of the third peripheral wall 421 and the inner peripheral surface of the second annular wall 422. The rear end portion of the input piston 44 protrudes further rearward relative to the second annular wall 422. The braking operation member 21 is coupled to the rear end portion of the input piston 44. Therefore, the input piston 44 moves in a direction of approaching the master piston 43 according to an operation amount of the braking operation member 21. Further, in the second fluid chamber R2, a gap is formed between the input piston 44 and the master piston 43.

The master spring 45 is disposed in the master chamber Rm of the main cylinder 41. The master spring 45 biases the master piston 43 rearward. Therefore, the master spring 45 is elastically compressed when the master piston 43 moves forward.

The input spring 46 is disposed in the second fluid chamber R2 of the cover cylinder 42. The input spring 46 biases the input piston 44 rearward. Therefore, the input spring 46 is elastically compressed when the input piston 44 moves forward.

In the master cylinder 31, the master chamber Rm is connected to the reservoir tank 24. Specifically, a portion near a rear end of the master chamber Rm is connected to the reservoir tank 24 via a port formed in the first peripheral wall 412 of the main cylinder 41. Therefore, when the master piston 43 moves forward from an initial position illustrated in FIG. 1, the master chamber Rm and the reservoir tank 24 are not connected. As a result, a hydraulic pressure in the master chamber Rm increases as the master piston 43 moves forward. For example, when a hydraulic pressure in the servo chamber Rs increases, the master piston 43 is moved forward by the hydraulic pressure in the servo chamber Rs. Accordingly, the hydraulic pressure in the master chamber Rm increases.

The master chamber Rm and the braking actuator 23 are connected via a first flow path 331. That is, the first flow path 331 is a flow path that connects some of the plurality of wheel cylinders 11 and the master chamber Rm. Specifically, the first flow path 331 connects the wheel cylinders 11 for the wheels FL and FR, which are corresponding to a second wheel cylinder, and the master chamber Rm. The first fluid chamber R1 and the second fluid chamber R2 are connected to each other via a second flow path 332. Further, the third fluid chamber R3 is connected to the reservoir tank 24 via a third flow path 333. Therefore, when the input piston 44 moves forward, the brake fluid is supplied from the reservoir tank 24 to the third fluid chamber R3. On the other hand, when the input piston 44 moves rearward, the brake fluid is discharged from the third fluid chamber R3 to the reservoir tank 24. The third flow path 333 connects the reservoir tank 24 and the second flow path 332.

A first control valve 341 is disposed in a portion of the second flow path 332 between a connection point with the third flow path 333 and the second fluid chamber R2. The first control valve 341 is a normally closed electromagnetic valve. The third flow path 333 is provided with a second control valve 342. The second control valve 342 is a normally open electromagnetic valve. When the control unit 100 of the braking device 20 is operating, the first control valve 341 is opened and the second control valve 342 is closed.

On the other hand, the stroke simulator 32 provided in the master device 30 together with the master cylinder 31 generates a reaction force corresponding to the operation amount of the braking operation member 21. The stroke simulator 32 is disposed between the first fluid chamber R1 and the first control valve 341 in the second flow path 332. For example, the stroke simulator 32 includes therein a piston (not illustrated) biased from a back surface by a spring. In this case, when the internal piston is displaced, against the biasing of the spring, by the brake fluid flowing in from the second flow path 332, the stroke simulator 32 generates a pressure in the brake fluid in response to the displacement of the piston. Specifically, when the input piston 44 is moved forward by the operation of the braking operation member 21 in a state where the first control valve 341 is opened and the second control valve 342 is closed, the brake fluid flows into the stroke simulator 32. As a result, the stroke simulator 32 generates the same pressure in the second fluid chamber R2 and the first fluid chamber R1 that are connected by the second flow path 332.

### Configuration of Braking Portion 50

Next, a configuration of the braking portion 50 will be described. The braking portion 50 includes an electric cylinder 51. The braking portion 50 can control a hydraulic pressure in the plurality of wheel cylinders 11 by operating the electric cylinder 51.

The braking portion 50 includes a fourth flow path 54, a fifth flow path 55, and a sixth flow path 58. The fourth flow path 54 connects the electric cylinder 51 and the reservoir tank 24. The sixth flow path 58 connects the braking actuator 23 and the electric cylinder 51. That is, the sixth flow path 58 is a flow path that connects some of the plurality of wheel cylinders 11 and the electric cylinder 51. Specifically, the sixth flow path 58 connects the wheel cylinders 11 for the wheels RL and RR, which are corresponding to a first wheel cylinder, and the electric cylinder 51. The fifth flow path 55 connects the servo chamber Rs of the master cylinder 31 and the sixth flow path 58. The electric cylinder 51 is provided between the fourth flow path 54 and the sixth flow path 58. The fourth flow path 54 is connected to an input port 515 of the electric cylinder 51. The sixth flow path 58 is connected to an output port 516 of the electric cylinder 51.

The braking portion 50 includes a release flow path 56 and a release valve 57. The release valve 57 is disposed in the release flow path 56. The release flow path 56 is a flow path that connects the reservoir tank 24 and the wheel cylinder 11 so as to bypass the electric cylinder 51. Hereinafter, both ends of the release flow path 56 will be referred to as a first end portion and a second end portion, respectively. The first end portion of the release flow path 56 is connected to the fourth flow path 54. On the other hand, the second end portion of the release flow path 56 is connected to the sixth flow path 58. Specifically, the release flow path 56 connects a portion between the reservoir tank 24 and the input port 515 in the fourth flow path 54 and a portion between the output port 516 and the braking actuator 23 in the sixth flow path 58. The release valve 57 is a normally closed electromagnetic valve that opens and closes the release flow path 56. That is, the release flow path 56 is closed while control of opening the release valve 57 is not executed.

### Configuration of Electric Cylinder 51

Next, a configuration of the electric cylinder 51 will be described. The electric cylinder 51 includes a cylinder 511, a piston 512, a first electric motor 513, and a conversion mechanism 514. The piston 512 is slidably provided in the cylinder 511. The first electric motor 513 is a power source of the electric cylinder 51. The conversion mechanism 514 converts a rotational motion of an output shaft of the first electric motor 513 into a linear motion of the piston 512.

Inside the cylinder 511, a hydraulic chamber Re into which the brake fluid is introduced is defined by a peripheral wall of the cylinder 511 and the piston 512. A position of the piston 512 inside the cylinder 511 can be changed by driving of the first electric motor 513. Hereinafter, a moving direction of the piston 512 for reducing a volume of the hydraulic chamber Re is referred to as a “forward direction Za”, and a direction opposite to the forward direction Za is referred to as a “retreat direction Zb”. The retreat direction Zb is a moving direction of the piston 512 for increasing the volume of the hydraulic chamber Re. Hereinafter, an end of a movable range of the piston 512 in the cylinder 511 in the retreat direction Zb is referred to as a “retreat limit position”.

The input port 515 and the output port 516 are formed in the peripheral wall of the cylinder 511 as ports connecting the hydraulic chamber Re and the outside. A through hole 517 is formed in the piston 512. The through hole 517 is formed at a position allowing the input port 515 and the hydraulic chamber Re to be connected when the piston 512 is positioned at the retreat limit position. Thus, when the piston 512 is positioned at the retreat limit position, the hydraulic chamber Re of the cylinder 511 is connected to the fourth flow path 54 via the input port 515 and the through hole 517. That is, the hydraulic chamber Re of the cylinder 511 communicates with the reservoir tank 24 via the input port 515 and the through hole 517. The input port 515 is opened when the piston 512 is positioned at the retreat limit position, and is closed by the piston 512 when the piston 512 moves in the forward direction Za from the retreat limit position. Thus, when the input port 515 is closed by the piston 512, the hydraulic pressure in the hydraulic chamber Re increases when the piston 512 moves in the forward direction Za. Thus, the input port 515 is an inlet for the brake fluid from the reservoir tank 24 to the hydraulic chamber Re.

The output port 516 of the cylinder 511 is connected to the braking actuator 23 and the fifth flow path 55 via the sixth flow path 58. The output port 516 is always open regardless of the position of the piston 512. Therefore, in a case where the input port 515 is closed by the piston 512, when the piston 512 moves in the forward direction Za, the brake fluid in the hydraulic chamber Re is discharged from the output port 516 to the outside of the cylinder 511. Thus, the output port 516 is an outlet for the brake fluid from the hydraulic chamber Re.

### Configuration of Braking Actuator 23

Next, a configuration of the braking actuator 23 will be described. The braking actuator 23 is capable of individually controlling hydraulic pressures in the plurality of wheel cylinders 11. The braking actuator 23 includes two pumps 631 and 632 that use a second electric motor 64 as a power source.

The braking actuator 23 can increase the hydraulic pressure in the wheel cylinder 11 without increasing a hydraulic pressure regulated by the braking portion 50. That is, the braking device 20 has a redundant configuration in which the braking portion 50 is on an upstream side and the braking actuator 23 is on a downstream side.

The braking actuator 23 includes two hydraulic circuits, that is, a first hydraulic circuit 611 and a second hydraulic circuit 612. The two wheel cylinders 11 for the wheels FL and FR are connected to the first hydraulic circuit 611. The two wheel cylinders 11 for the wheels RL and RR are connected to the second hydraulic circuit 612.

The first hydraulic circuit 611 is connected to the reservoir tank 24 via the first flow path 331 and the master chamber Rm. In the first hydraulic circuit 611, a first differential pressure control valve 621, which is a normally open linear electromagnetic valve, is provided in a fluid path connecting a connection point with the first flow path 331 and the wheel cylinder 11.

The second hydraulic circuit 612 is connected to the reservoir tank 24 via the fourth flow path 54, the electric cylinder 51, and the sixth flow path 58. In the second hydraulic circuit 612, a second differential pressure control valve 622, which is a normally open linear electromagnetic valve, is provided in a fluid path connecting a connection point with the sixth flow path 58 and the wheel cylinder 11.

The pump 631 provided in the first hydraulic circuit 611. The pump 631 supplies the brake fluid to a fluid path connecting the first differential pressure control valve 621 and the wheel cylinder 11. The pump 632 is provided in the second hydraulic circuit 612. The pump 632 supplies the brake fluid to a fluid path connecting the second differential pressure control valve 622 and the wheel cylinder 11.

In the first hydraulic circuit 611, the same number of paths 65a and 65b as the wheel cylinders 11 connected to the first hydraulic circuit 611 are provided closer to the wheel cylinder 11 than is the first differential pressure control valve 621. Similarly, in the second hydraulic circuit 612, the same number of paths 65c and 65d as the wheel cylinders 11 connected to the second hydraulic circuit 612 are provided closer to the wheel cylinder 11 than is the second differential pressure control valve 622. Each of the plurality of paths 65a to 65d is provided with a holding valve 66 that is closed when restricting an increase in the hydraulic pressure in the wheel cylinder 11 and a pressure reducing valve 67 that is opened when reducing the hydraulic pressure. That is, the holding valve 66 is disposed in the fluid path closer to the wheel cylinder 11 than are the first differential pressure control valve 621 and the second differential pressure control valve 622. The plurality of holding valves 66 are normally open electromagnetic valves, and the plurality of pressure reducing valves 67 are normally closed electromagnetic valves.

The first hydraulic circuit 611 and the second hydraulic circuit 612 are connected to reservoirs 681 and 682, respectively that temporarily stores the brake fluid flowing out from the wheel cylinder 11 via the pressure reducing valve 67 when the pressure reducing valve 67 is open. The plurality of reservoirs 681 and 682 are connected to the pumps 631 and 632 via intake flow paths 691 and 692.

The reservoir 681 is connected to a fluid path, which connects the first differential pressure control valve 621 and the master chamber Rm, via a tank-side flow path 701. The reservoir 682 is connected to a fluid path, which connects the connection point with the sixth flow path 58 and the second differential pressure control valve 622 in the second hydraulic circuit 612, via a tank-side flow path 702.

The plurality of pumps 631 and 632 can pump out the brake fluid in the reservoir tank 24 via the reservoirs 681 and 682. The plurality of pumps 631 and 632 discharge the pumped brake fluid to fluid paths between the first differential pressure control valve 621 and the second differential pressure control valve 622 and the holding valves 66. Hereinafter, fluid paths between the fluid paths and the pumps 631 and 632 are referred to as intermediate fluid paths 711 and 712, respectively.

### Detection System of Braking Device 20

The braking device 20 includes a detection system including a plurality of sensors. The plurality of sensors constituting the detection system include a stroke sensor SE1, a rotation angle sensor SE2, a master hydraulic pressure sensor 351, an input hydraulic pressure sensor 352, and a control pressure sensor 353.

The stroke sensor SE1 detects an operation amount of the braking operation member 21. The rotation angle sensor SE2 detects a rotation angle of the first electric motor 513 that is a power source of the electric cylinder 51. The rotation angle of the first electric motor 513 based on a detection value of the rotation angle sensor SE2 is referred to as a “motor rotation angle θmt”.

The master hydraulic pressure sensor 351 detects the hydraulic pressure in the master chamber Rm. For example, the master hydraulic pressure sensor 351 is provided in the first flow path 331. The hydraulic pressure in the master chamber Rm based on a detection value of the master hydraulic pressure sensor 351 is referred to as a “master pressure”.

The input hydraulic pressure sensor 352 detects the hydraulic pressure in the second fluid chamber R2. For example, the input hydraulic pressure sensor 352 is connected to a position between the first control valve 341 and the second fluid chamber R2 in the second flow path 332. The hydraulic pressure in the second fluid chamber R2 based on a detection value of the input hydraulic pressure sensor 352 is referred to as an “input hydraulic pressure”.

The control pressure sensor 353 is a hydraulic pressure sensor that detects a hydraulic pressure of the brake fluid discharged by the electric cylinder 51. For example, the control pressure sensor 353 is provided near the output port 516 of the electric cylinder 51. As an example, FIG. 1 illustrates a configuration in which the control pressure sensor 353 is connected between the release valve 57 and the output port 516 in the release flow path 56. The discharge hydraulic pressure of the electric cylinder 51 based on a detection value of the control pressure sensor 353 is referred to as a “control pressure Psc”. In the embodiment, the control pressure sensor 353 corresponds to a hydraulic pressure sensor that detects the hydraulic pressure of the brake fluid discharged by the electric cylinder 51.

### Configuration of Control Unit 100

The braking device 20 includes the control unit 100. The control unit 100 is, for example, an electronic control device. In this case, the control unit 100 includes a CPU and a memory. The memory stores a control program to be executed by the CPU. Detection signals from the sensors constituting the detection system of the braking device 20 are input to the control unit 100. The control unit 100 controls the operations of the hydraulic pressure generation device 22 and the braking actuator 23 by the CPU executing the control program. More specifically, the control unit 100 controls the first control valve 341, the second control valve 342, and the release valve 57 of the hydraulic pressure generation device 22, and the first electric motor 513 of the electric cylinder 51. The control unit 100 controls the various electromagnetic valves (621, 622, 66, and 77) of the braking actuator 23 and the second electric motor 64.

### Drive Control for Electric Cylinder 51

Next, drive control for the electric cylinder 51 executed by the control unit 100 will be described. When the driver starts the vehicle, power is supplied to the braking device 20. The control unit 100 is started by receiving the power supply.

The control unit 100 executes drive preparation processing for the electric cylinder 51 after the start. In the drive preparation processing, the control unit 100 first commands the first electric motor 513 of the electric cylinder 51 to rotate in a direction for moving the piston 512 in the retreat direction Zb. When this command is continued, the piston 512 moves in the retreat direction Zb until reaching the retreat limit position. When the piston 512 reaches the retreat limit position, since the movement of the piston 512 is mechanically restricted, a load of the first electric motor 513 increases. Based on an increase in a current value of the first electric motor 513 with the increase in the load, the control unit 100 confirms that the piston 512 reaches the retreat limit position. When the reaching the retreat limit position is confirmed, the control unit 100 temporarily stops the rotation of the first electric motor 513. Next, the control unit 100 commands the first electric motor 513 to rotate by a predetermined rotation amount Xm in a direction for moving the piston 512 in the forward direction Za. Accordingly, the piston 512 moves in the forward direction Za by a predetermined amount from the retreat limit position. Hereinafter, the position of the piston 512 at this time is referred to as a standby position. A movement position of the piston 512 where the input port 515 is switched between an opened state and a closed state by the piston 512 is referred to as a pressurization start position. The predetermined rotation amount Xm is set such that a position displaced in the retreat direction Zb relative to the pressurization start position and displaced in the forward direction Za relative to the retreat limit position is the standby position. In order to improve the responsiveness of the braking device 20, it is desirable to set, as the standby position, a position close to the pressurization start position in a range in which the input port 515 is reliably opened.

Thereafter, the control unit 100 determines presence or absence of a braking request based on a detection signal of the stroke sensor SE1 or the like. If it is determined that there is no braking request, the control unit 100 holds the piston 512 of the electric cylinder 51 at the standby position. On the other hand, if it is determined that there is a braking request, the control unit 100 drives the first electric motor 513 to move the piston 512 in the forward direction Za. When the piston 512 moves in the forward direction Za from the standby position, the input port 515 is closed by the piston 512. The brake fluid in the hydraulic chamber Re is discharged from the output port 516 by being pressed by the piston 512. Thus, the braking device 20 supplies the brake fluid to the wheel cylinders 11 of the wheels FL, FR, RL, and RR to generate a braking force. When the braking request is released during the generation of the braking force, the control unit 100 drives the first electric motor 513 to move the piston 512 in the retreat direction Zb to the standby position.

### Output Calibration for Control Pressure Sensor 353

As described above, the braking device 20 includes the control pressure sensor 353 that detects the control pressure Psc that is the hydraulic pressure of the brake fluid discharged by the electric cylinder 51. The control unit 100 calculates the control pressure Psc based on an output of the control pressure sensor 353. Hereinafter, the control pressure Psc calculated by the control unit 100 based on the output of the control pressure sensor 353 is referred to as a detection value of the control pressure Psc.

Output characteristics of the control pressure sensor 353 have temperature dependence. The detection value of the control pressure Psc may deviate from an actual value due to a change in the output characteristics of the control pressure sensor 353 caused by temperature. In the braking device 20 according to the embodiment, output calibration for the control pressure sensor 353 for correcting the deviation in the detection value of the control pressure Psc due to such a change in the output characteristics is executed.

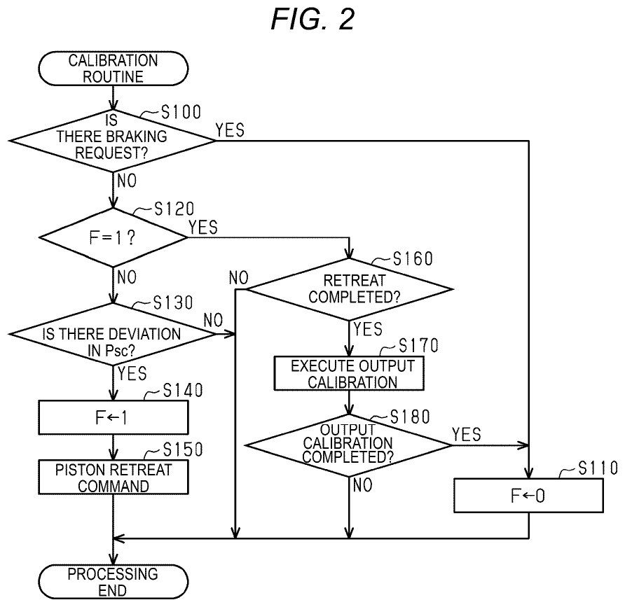

FIG. 2 illustrates a flowchart of a calibration routine executed by the control unit 100 to execute the output calibration for the control pressure sensor 353. The control unit 100 repeatedly executes the same routine every predetermined control cycle during the operation of the braking device 20.

When this routine is started, the control unit 100 first determines whether there is a braking request in step S100. For example, when a detection value of the operation amount of the braking operation member 21 obtained by the stroke sensor SE1 is not “0”, the control unit 100 determines that there is a braking request.

If there is a braking request (S100: YES), the control unit 100 advances the processing to step S110. In step S110, the control unit 100 sets a value of a calibration request flag F to “0”, and then ends the processing of this routine in the current control cycle. The calibration request flag F is a flag indicating that the output calibration for the control pressure sensor 353 is being executed when the value is “1”.

On the other hand, if there is no braking request (S100: NO), the control unit 100 advances the processing to step S120. In step S120, the control unit 100 determines whether the value of the calibration request flag F is “1”. If the value of the calibration request flag F is “0” (NO), the control unit 100 advances the processing to step S130, and if the value is “1” (YES), the control unit 100 advances the processing to step S160.

When the processing is advanced to step S130, the control unit 100 determines in step S130 whether there is a deviation in the detection value of the control pressure Psc obtained by the control pressure sensor 353. If there is no braking request, the control unit 100 controls the first electric motor 513 such that the position of the piston 512 of the electric cylinder 51 is the standby position. Since the input port 515 is open at the standby position, the hydraulic chamber Re of the electric cylinder 51 communicates with the reservoir tank 24. The control pressure Psc at this time has a value equivalent to the atmospheric pressure. Therefore, when the amount of deviation in the detection value of the control pressure Psc from the value equivalent to the atmospheric pressure is equal to or greater than a predetermined threshold, the control unit 100 determines that there is a deviation in the detection value of the control pressure Psc.

If it is determined that there is no deviation in the detection value of the control pressure Psc (S130: NO), the control unit 100 ends the current processing of this routine. On the other hand, if it is determined that there is a deviation in the detection value of the control pressure Psc (S130: YES), the control unit 100 advances the processing to step S140.

In step S140, the control unit 100 sets the value of the calibration request flag F to “1”. In the subsequent step S150, the control unit 100 commands the piston 512 to retreat from the standby position. That is, the control unit 100 commands the first electric motor 513 to move the piston 512 to a position displaced in the retreat direction Zb relative to the standby position. After the command, the control unit 100 ends the processing of this routine in the current control cycle.

On the other hand, if the processing is advanced to step S160, the control unit 100 determines in step S160 whether the retreat of the piston 512 commanded in step S150 is completed. For example, when the rotation amount of the first electric motor 513 after the command in step S150 reaches a predetermined amount, the control unit 100 determines that the retreat of the piston 512 is completed. If the retreat of the piston 512 is not completed (NO), the control unit 100 ends the processing of this routine in the current control cycle. On the other hand, if the retreat of the piston 512 is completed (YES), the control unit 100 advances the processing to step S170.

In step S170, the control unit 100 executes the output calibration for the control pressure sensor 353. For example, the control unit 100 obtains a deviation amount of the output of the control pressure sensor 353 based on an average value of the output in a predetermined period. Thereafter, the control unit 100 corrects the output of the control pressure sensor 353 by the deviation amount. In the embodiment, the output calibration for the control pressure sensor 353 requires a plurality of control cycles.

Next, in step S180, the control unit 100 determines whether the output calibration for the control pressure sensor 353 is completed in the current control cycle. If the output calibration is not completed (NO), the control unit 100 ends the processing of this routine in the current control cycle. On the other hand, if the output calibration is completed (YES), the control unit 100 sets the value of the calibration request flag F to “0” in step S110, and then ends the processing of this routine in the current control cycle.

### Operation and Effect of Embodiment

An operation and effect of the embodiment will be described.

When a deviation in the output of the control pressure sensor 353 is confirmed during the operation of the braking device 20, the control unit 100 executes the output calibration for the control pressure sensor 353. This output calibration is executed on the premise that the input port 515 of the electric cylinder 51 is opened.

When the braking request is released, the control unit 100 controls the first electric motor 513 to return the piston 512 to the standby position. However, it is conceivable that the piston 512 stops at a position displaced in the forward direction Za relative to the standby position without completely returning to the standby position. In this case, since the input port 515 is not opened, a residual pressure is generated in the hydraulic chamber Re. In such a state where the residual pressure is generated, the output calibration for the control pressure sensor 353 cannot be appropriately executed.

On the other hand, in the embodiment, when the deviation in the output of the control pressure sensor 353 is confirmed, the control unit 100 first commands the first electric motor 513 to move the piston 512 in the retreat direction Zb relative to the standby position. Then, the control unit 100 executes the output calibration for the control pressure sensor 353 based on an output of the control pressure sensor 353 after the command. That is, after commanding the first electric motor 513 to move the piston 512 in the retreat direction Zb relative to the standby position, the control unit 100 executes calibration processing of executing output calibration for the control pressure sensor 353. In such a case, even when the piston 512 is stopped at a position displaced in the forward direction Za relative to the standby position before execution of the output calibration and a residual pressure is generated in the hydraulic chamber Re, there is a high possibility that the input port 515 is opened during the output calibration. Therefore, the output calibration is less likely to be inappropriately executed in a state where the input port 515 is not opened. Therefore, the braking device 20 according to the embodiment has an effect of easily maintaining the detection accuracy of the control pressure sensor 353 when the output characteristics change.

Since the electric cylinder 51 in a case where the generation of a braking force is not requested is controlled in a state where the input port 515 is opened, the control pressure Psc has a value equivalent to the atmospheric pressure. Therefore, when the detection value of the hydraulic pressure by the control pressure sensor 353 at this time deviates from the value equivalent to the atmospheric pressure, it can be determined that there is a deviation in the output of the control pressure sensor 353. On the other hand, the control unit 100 executes the calibration processing in a case where a difference between the detection value of the hydraulic pressure obtained by the control pressure sensor 353 when the generation of a braking force is not requested and the value equivalent to the atmospheric pressure is equal to or greater than a threshold. Therefore, when there is a deviation in the output of the control pressure sensor 353 due to the ambient temperature or the like during the operation of the braking device 20, the deviation can be quickly corrected.

When the generation of a braking force is requested during the execution of the calibration processing, the control unit 100 immediately stops the calibration processing at that time. Therefore, the generation of a braking force is less likely to be delayed by the execution of the calibration processing.

The control unit 100 retreats the piston 512 to a retreat limit position in the drive preparation processing for the electric cylinder 51. The control unit 100 executes the output calibration for the control pressure sensor 353 even when the piston 512 is moved in the retreat direction Zb relative to the standby position during the drive preparation processing.

### Second Embodiment

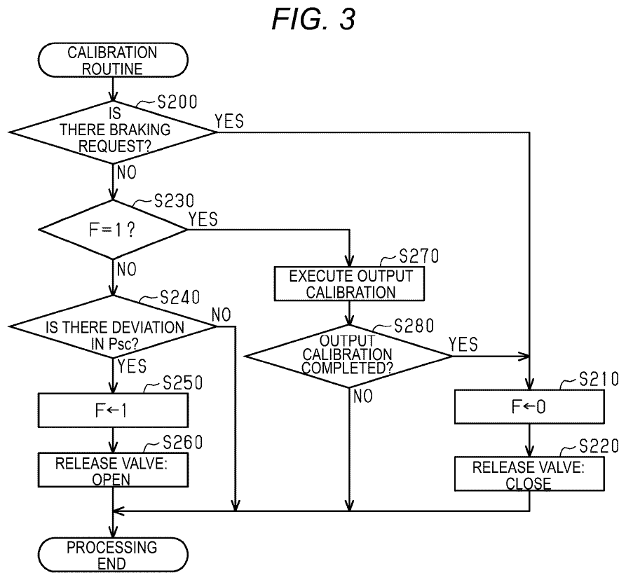

Next, a braking device according to a second embodiment will be described in detail with reference to FIG. 3.

### Output Calibration for Control Pressure Sensor 353

A hardware configuration of the braking device according to the embodiment is the same as that in FIG. 1. The braking device according to the embodiment is different from that according to the first embodiment in the content of the calibration processing.

FIG. 3 illustrates a flowchart o a calibration routine executed by the control unit 100 of the braking device 20 according to the embodiment. The control unit 100 repeatedly executes the same routine every predetermined control cycle during the operation of the braking device 20.

When this routine is started, the control unit 100 first determines whether there is a braking request in step S200. The control unit 100 advances the processing to step S210 if there is a braking request (YES), and advances the processing to step S230 if there is no braking request (NO).

In step S210, the control unit 100 sets a value of a calibration request flag F to “0”. In step S220, the control unit 100 commands to close the release valve 57, and then ends the processing of this routine in the current control cycle.

On the other hand, in step S230, the control unit 100 determines whether the value of the calibration request flag F is “1”. If the value of the calibration request flag F is “0” (NO), the control unit 100 advances the processing to step S240, and if the value is “1” (YES), the control unit 100 advances the processing to step S270.

In step S240, the control unit 100 determines whether there is a deviation in a detection value of the control pressure Psc obtained by the control pressure sensor 353. If it is determined that there is no deviation in the detection value of the control pressure Psc (S240: NO), the control unit 100 ends the current processing of this routine. On the other hand, if it is determined that there is a deviation in the detection value of the control pressure Psc (S240: YES), the control unit 100 advances the processing to step S250.

In step S250, the control unit 100 sets the value of the calibration request flag F to “1”. After commanding to open the release valve 57 in the subsequent step S260, the control unit 100 ends the processing of this routine in the current control cycle.

On the other hand, in step S270, the control unit 100 executes the calibration processing as in step S170 in FIG. 2. In the subsequent step S280, the control unit 100 determines whether the calibration processing is completed. If the calibration processing is completed (YES), the control unit 100 advances the processing to step S210 described above, and if the calibration processing is not completed (NO), the control unit 100 ends the processing of this routine in the current control cycle.

### Operation and Effect of Embodiment

An operation and effect of the embodiment will be described.

Also in the embodiment, when a deviation in the output of the control pressure sensor 353 is confirmed during the operation of the braking device 20, the control unit 100 executes the output calibration for the control pressure sensor 353. In the output calibration, the control unit 100 opens the release valve 57. When the release valve 57 is opened, the output port 516 of the electric cylinder 51 and the reservoir tank 24 communicate with each other via the release flow path 56. As a result, the control pressure Psc has a value equivalent to the atmospheric pressure regardless of whether the input port 515 of the electric cylinder 51 is opened. Therefore, similarly to the first embodiment, the braking device 20 according to the embodiment also has an effect of easily maintaining the detection accuracy of the control pressure sensor 353 with respect to a change in output characteristics. When the calibration processing is completed and when the generation of a braking force is requested during the calibration processing, the control unit 100 quickly closes the release valve 57.

### Other Embodiments

The above embodiments can be modified and implemented as follows. The embodiment and the following modifications can be implemented in combination with each other within a technically consistent range.

In step S150 in FIG. 2, the retreat of the piston 512 to the retreat limit position may be commanded. In this case, the determination about retreat completion in step S160 in FIG. 2 can be made based on an increase in a current value of the first electric motor 513.

The content of the calibration processing in step S170 in FIG. 2 and step S270 in FIG. 3 may be changed as appropriate. For example, the calibration processing may be executed by obtaining a deviation amount of the output of the control pressure sensor 353 from an instantaneous value of the output.

Output calibration for the master hydraulic pressure sensor 351 may be executed together with the output calibration for the control pressure sensor 353 through the calibration routine in FIG. 2 or 3.

The configuration of the braking device 20 may be different from that in FIG. 1 as long as the braking device 20 includes the electric cylinder 51 and a hydraulic pressure sensor that detects the hydraulic pressure of the brake fluid discharged by the electric cylinder 51.

The braking portion 50 of the first embodiment may not include the release flow path 56 and the release valve 57. In this case, the control pressure sensor 353 installed in the release flow path 56 in FIG. 1 is preferably installed in the fifth flow path 55 or in a portion between the second differential pressure control valve 622 and the output port 516 of the electric cylinder 51 in the sixth flow path 58.

When executing the calibration processing for the control pressure sensor 353, as a method of setting the control pressure Psc to be equivalent to the atmospheric pressure, whether to use the piston 512 or the release valve 57 may be selected according to a predetermined condition. For example, during traveling, the calibration processing for the control pressure sensor 353 is executed by setting the control pressure Psc equivalent to the atmospheric pressure using the release valve 57. On the other hand, while the vehicle is stopped, the calibration processing for the control pressure sensor 353 may be executed by setting the control pressure Psc equivalent to the atmospheric pressure using the piston 512.

The control unit 100 may be implemented as a circuit including one or more processors that operate in accordance with a computer program, one or more dedicated hardware circuits such as dedicated hardware that executes some processing of various types of processing, or a combination thereof. Examples of dedicated hardware include an application-specific integrated circuit (ASIC). The processor includes a CPU and a memory, such as a RAM and a ROM, and the memory stores program codes or commands configured to cause the CPU to execute processing. The memory, that is, a storage medium includes any available medium that can be accessed by a general-purpose or dedicated computer.

1. A braking device comprising:
a reservoir tank configured to store a brake fluid;
an electric cylinder configured to discharge the brake fluid by moving a piston in the cylinder in response to driving by an electric motor;
a hydraulic pressure sensor configured to detect a hydraulic pressure of the brake fluid discharged by the electric cylinder; and
a control unit configured to control the electric motor,
the braking device being configured to generate a braking force on a wheel by supplying the brake fluid to a wheel cylinder in response to discharge of the brake fluid from the electric cylinder, wherein
the electric cylinder includes a hydraulic chamber defined by a peripheral wall of the cylinder and the piston, an input port that is an inlet for the brake fluid from the reservoir tank to the hydraulic chamber, and an output port that is an outlet for the brake fluid from the hydraulic chamber,
the electric cylinder is configured such that, when a moving direction of the piston for reducing a volume of the hydraulic chamber is defined as a forward direction, a direction opposite to the forward direction is defined as a retreat direction and a furthest position in the retreat direction in a movable range of the piston is defined as a retreat limit position, the input port is opened when the piston is positioned at the retreat limit position, and when the piston is moved in the forward direction from the retreat limit position and the input port is closed, the hydraulic pressure in the hydraulic chamber increases and the brake fluid is discharged from the output port,
the control unit holds the piston at a standby position set between a position where the input port is switched between a closed state and an opened state and the retreat limit position when generation of the braking force is not requested, and controls the electric motor to move the piston in the forward direction from the standby position when the generation of the braking force is requested, and
the control unit executes calibration processing of executing output calibration for the hydraulic pressure sensor after commanding the electric motor to move the piston in the retreat direction relative to the standby position.

2. A braking device comprising:
a reservoir tank configured to store a brake fluid;
an electric cylinder configured to discharge the brake fluid by moving a piston in the cylinder in response to driving by an electric motor;
a hydraulic pressure sensor configured to detect a hydraulic pressure of the brake fluid discharged by the electric cylinder; and
a control unit configured to control the electric motor,
the braking device being configured to generate a braking force on a wheel by supplying the brake fluid to a wheel cylinder in response to discharge of the brake fluid from the electric cylinder, wherein
the electric cylinder includes a hydraulic chamber defined by a peripheral wall of the cylinder and the piston, an input port that is an inlet for the brake fluid from the reservoir tank to the hydraulic chamber, and an output port that is an outlet for the brake fluid from the hydraulic chamber,
the electric cylinder is configured such that, when a moving direction of the piston for reducing a volume of the hydraulic chamber is defined as a forward direction, a direction opposite to the forward direction is defined as a retreat direction and a furthest position in the retreat direction in a movable range of the piston is defined as a retreat limit position, the input port is opened when the piston is positioned at the retreat limit position, and when the piston is moved in the forward direction from the retreat limit position and the input port is closed, the hydraulic pressure in the hydraulic chamber increases and the brake fluid is discharged from the output port,
the braking device further comprises a release flow path configured to establish communication between the output port and the reservoir tank without passing through the hydraulic chamber, and a release valve configured to open and close the release flow path,
the control unit holds the piston at a standby position set between a position where the input port is switched between a closed state and an opened state and the retreat limit position when generation of the braking force is not requested, and controls the electric motor to move the piston in the forward direction from the standby position when the generation of the braking force is requested, and
the control unit executes calibration processing of executing output calibration for the hydraulic pressure sensor in a state where the release valve is opened.

3. The braking device according to claim 2, wherein the control unit executes the calibration processing in a case where a difference between a detection value of the hydraulic pressure obtained by the hydraulic pressure sensor when the generation of the braking force is not requested and a value equivalent to an atmospheric pressure is equal to or greater than a threshold.

4. The braking device according to claim 2, wherein the control unit stops the calibration processing when the generation of the braking force is requested during execution of the calibration processing.

5. The braking device according to claim 1, wherein the control unit executes the calibration processing in a case where a difference between a detection value of the hydraulic pressure obtained by the hydraulic pressure sensor when the generation of the braking force is not requested and a value equivalent to an atmospheric pressure is equal to or greater than a threshold.

6. The braking device according to claim 1, wherein the control unit stops the calibration processing when the generation of the braking force is requested during execution of the calibration processing.
